(19) United States
(12) Patent Application Publication
(10) Pub. No.: US 2012/0014145 A1
(43) Pub. Date: Jan. 19, 2012

(54) STARTUP CIRCUIT

(75) Inventor: Kengo KOIKE, Niiza-shi (JP)

(73) Assignee: Sanken Electric Co., Ltd., Niiza-shi (JP)

(21) Appl. No.: 13/177,855

(22) Filed: Jul. 7, 2011

(30) Foreign Application Priority Data
Jul. 13, 2010 (JP) 2010-158684

(51) Int. Cl. H02M 7/02

(52) U.S. Cl. 363/49

(57) ABSTRACT

A startup circuit is installed in a switching power source apparatus. The startup circuit is configured to start up a controller with the use of a rectified voltage at startup of an AC power source and includes a detector (ZD3, Q4, Q6) to detect if the rectified voltage is equal to or lower than a predetermined voltage, a timer 20 to count a predetermined time after the rectified voltage is detected to be equal to or lower than the predetermined voltage, and a discharger (R10, Q7) to discharge the rectified voltage if the rectified voltage does not become equal to or lower than a specified voltage within the predetermined time counted by the timer.

### BACKGROUND OF THE INVENTION

1. Field of the Invention

The present invention relates to a startup circuit installed in a switching power source apparatus, to reduce power consumption in a standby mode such as a waiting mode of a remote control command.

2. Description of Related Art

FIG. 1 is a circuit diagram illustrating a switching power source apparatus incorporating a startup circuit according to a related art. In FIG. 1, both ends of an AC power source AC are connected to a capacitor C0, a discharge resistor R0, and input ends of a full-wave rectifier DB. Output ends of the full-wave rectifier DB are connected to a smoothing capacitor C1 and a series circuit that includes a primary winding P of a transformer T, a switch element Q1 made of a MOSFET, and a resistor R2. Both ends of the primary winding P are connected to a series circuit that includes a capacitor C2 and a diode D1. Both ends of the capacitor C2 are connected to a resistor R1.

Both ends of a secondary winding S of the transformer T are connected to a series circuit that includes a diode D3 and a capacitor C4. Both ends of the capacitor C4 are connected to a series circuit that includes a resistor R3, a photodiode of a photocoupler PC, and a shunt regulator Z1 and to a series circuit that includes resistors R4 and R5. Both ends of a series circuit that includes the resistor R3 and the photodiode of the photocoupler PC are connected to a resistor R2. A connection point of the resistors R4 and R5 and a connection point of the shunt regulator Z1 and the photodiode of the photocoupler PC are connected to a capacitor C5.

Both ends of an auxiliary winding C of the transformer T are connected to a series circuit that includes a diode D2, a resistor R2a, and a capacitor C3. A controller 1a includes the startup circuit 10a that activates the controller 1a to turn on/off the switch element Ql. The controller 1a has a terminal STARTUP connected to a first end of the capacitor C1, a terminal GND (ground) connected to a second output end of the full-wave rectifier DB, a terminal VCC connected to a connection point of the capacitor C3 and resistor R2a, a terminal FB (feedback) connected to a phototransistor of the photocoupler PC, a terminal DRIVE connected to a gate of the switch element Q1, and a terminal OCP connected to a connection point of the resistor R2 and a source of the switch element Q1.

In the switching power source apparatus of FIG. 1, an AC voltage from the AC power source AC is rectified by the full-wave rectifier DB and is smoothed by the capacitor C1 into a DC voltage. The DC voltage is converted into a high-frequency voltage by the switch element Q1 that is turned on/off in response to a control signal from the controller 1a. The high-frequency voltage causes the windings of the transformer T to generate high-frequency voltages.

The high-frequency voltage generated by the secondary winding S of the transformer T is rectified and smoothed by the diode D3 and capacitor C4 into a DC output voltage. The DC output voltage is fed back through the photocoupler PC to the controller 1a, and according to the DC output voltage, the controller 1a controls the ON/OFF duty or frequency of the switch element Q1, to thereby control the DC output voltage to a predetermined voltage.

The startup circuit 10a according to the related art will be explained with reference to FIG. 2. In the startup circuit 10a, first ends of resistors R6 and R7 are connected to the terminal STARTUP of the controller 1a. A second end of the resistor R6 is connected to a gate of a switch element Q2 made of a MOSFET, a cathode of a zener diode ZD2, and a drain of a switch element Q3 made of a MOSFET. An anode of the zener diode ZD2 is connected to a source of the switch element Q3, a negative electrode of a reference power source Vref1, and the terminal GND of the controller 1a.

A second end of the resistor R7 is connected to a drain of the switch element Q2. A source of the switch element Q2 is connected to an anode of a diode D4. A cathode of the diode D4 is connected to the terminal VCC and a non-inverting input terminal (+) of a hysteresis comparator CMP1. An inverting input terminal (−) of the hysteresis comparator CMP1 is connected to a positive electrode of the reference power source Vref1. An output terminal of the hysteresis comparator CMP1 is connected to a gate of the switch element Q3 and the reference power source Vref1.

Operation of the startup circuit 10a will be explained. At startup of the AC power source AC, a DC voltage of the capacitor C1 is applied to the terminal STARTUP, to turn on the switch element Q2 and diode D4 and supply a current to the terminal VCC to start the controller 1a. In a normal state, the started controller 1a turns on/off the switch element Q1 to generate a high-frequency voltage on the auxiliary winding C. This high-frequency voltage is rectified and smoothed by the diode D2 and capacitor C3 into a DC voltage which is applied to the terminal VCC.

At this time, the turning on/off of the high-voltage switch element Q2 is stabilized by the hysteresis characteristic of the comparator CMP1. For example, the switch element Q2 turns on if VCC=10 V or lower and off if VCC=17 V or higher. At startup of the AC power source AC, the terminal STARTUP receives, for example, 340 V so that the zener diode ZD2 breaks down to turn on the switch element Q2 and set the terminal VCC to 17 V. The zener diode ZD2 has a zener voltage of, for example, 28 V.

Then, the comparator CMP1 provides a high-level output to turn on the switch element Q3 and decrease the gate potential of the switch element Q2 lower than the source potential of the same. This results in turning off the switch element Q2.

The auxiliary winding C of the transformer T is set to rise to a set voltage (for example, 20 V) during a period in which a current of the controller 1a decreases the voltage of the terminal VCC from 17 V to 10 V. In a steady state after the switch element Q2 turns off, the auxiliary winding C of the transformer T serves as a power source for the controller 1a.

### SUMMARY OF THE INVENTION

In the switching power source apparatus of FIG. 1, the discharge resistor R0 connected between AC lines of an AC plug connected to the AC power source AC generally has a resistance of about 2 MΩ, although the value is dependent on the capacitance of the capacitor C0 serving as an EMI (electromagnetic interference) filter. When the AC plug is removed from an AC plug of the AC power source AC, the capacitor C0 is discharged through the discharge resistor R0, to prevent an electric shock.

The discharge resistor R0 is generally designed to discharge the capacitor C0 to a voltage that causes no electric shock even when a person touches the AC plug within one second after the removal of the AC plug from the AC socket. This discharging procedure must follow regulations, guidelines, or internal safety design rules of electric equipment manufacturers.

If the discharge resistor R0 connected between the AC lines of the AC plug is of 2 MΩ, the resistance of 2 MΩ always consumes power to cause a power loss. If the AC power source AC is of 100 V or 240 V, the power loss is constantly about 5 mW or 30 mW. During a standby state, power consumption by the discharge resistor RO increases its ratio to total power consumption, to waste power.

For electric home appliances such as liquid crystal televisions (LCD-TVs), various regulations and guidelines are set to reduce total power consumption in a remote control standby state. Such regulations will become severer in the future, and therefore, power consumption by the discharge resistor is not ignorable.

DC power source apparatuses capable of reducing standby power and controlling the discharge time constant of an across-the-line capacitor are disclosed in, for example, Japanese Unexamined Patent Application Publications No. 2001-95261 (Patent Document 1) and No. 2006-204028 (Patent Document 2). The technique of Patent Document 1 connects a discharge circuit in parallel with the across-the-line capacitor.

As illustrated in FIG. 1 of Patent Document 1, the technique of Patent Document 1 always passes a current through a time constant circuit (resistor 3 and capacitor 4) to provide a base current to transistors 10 and 12 for controlling a discharge resistance, to thereby consume power in a standby mode.

As illustrated in FIG. 1 of Patent Document 2, the technique of Patent Document 2 needs, in addition to an across-the-line capacitor C5, capacitors C1 and C2 to provide a signal to turn on a transistor Q3 in a steady state. This results in increasing a parts mounting area. Namely, this related art needs an extra parts space only for a discharge circuit. Since the DC power source apparatus is connected to AC lines, specifications of parts to be selected are limited by safety regulations, to limit design conditions.

The present invention provides a startup circuit capable of eliminating a discharge resistor connected between AC lines of an AC plug and reducing power consumption during a standby state.

According to an aspect of the present invention, the startup circuit is installed in a switching power source apparatus that rectifies and smooths an AC voltage from an AC power source into a rectified-and-smoothed voltage, turns on/off the rectified-and-smoothed voltage with a controller to generate high-frequency voltages on primary and secondary windings of a transformer, and rectifies and smooths the high-frequency voltage of the secondary winding into a DC output voltage. The startup circuit is configured to start up the controller by use of the rectified voltage at startup of the AC power source. The startup circuit includes a detector configured to detect if the rectified voltage is equal to or lower than a predetermined voltage, a timer configured to count a predetermined time after the rectified voltage is detected to be equal to or lower than the predetermined voltage, and a discharger configured to discharge the rectified voltage if the rectified voltage does not become equal to or lower than a specified voltage within the predetermined time counted by the timer.

The timing of starting to count the predetermined time by the timer is optional within a period (t0 to t0′) in which the rectified voltage is equal to or lower than the predetermined voltage.

### BRIEF DESCRIPTION OF THE DRAWINGS

FIG. 1 is a circuit diagram illustrating a switching power source apparatus including a startup circuit according to a related art;

FIG. 2 is a circuit diagram illustrating the startup circuit of FIG. 1;

FIG. 3A is a circuit diagram illustrating a switching power source apparatus including a startup circuit according to Embodiment 1 of the present invention;

FIG. 3B is a circuit diagram illustrating the startup circuit of FIG. 3A;

FIG. 4 is a waveform diagram illustrating operation of the startup circuit of FIG. 3B; and

FIG. 5 is a circuit diagram illustrating a startup circuit according to Embodiment 2 of the present invention.

### DESCRIPTION OF PREFERRED EMBODIMENTS

Startup circuits according to embodiments of the present invention will be explained in detail with reference to the drawings.

### Embodiment 1

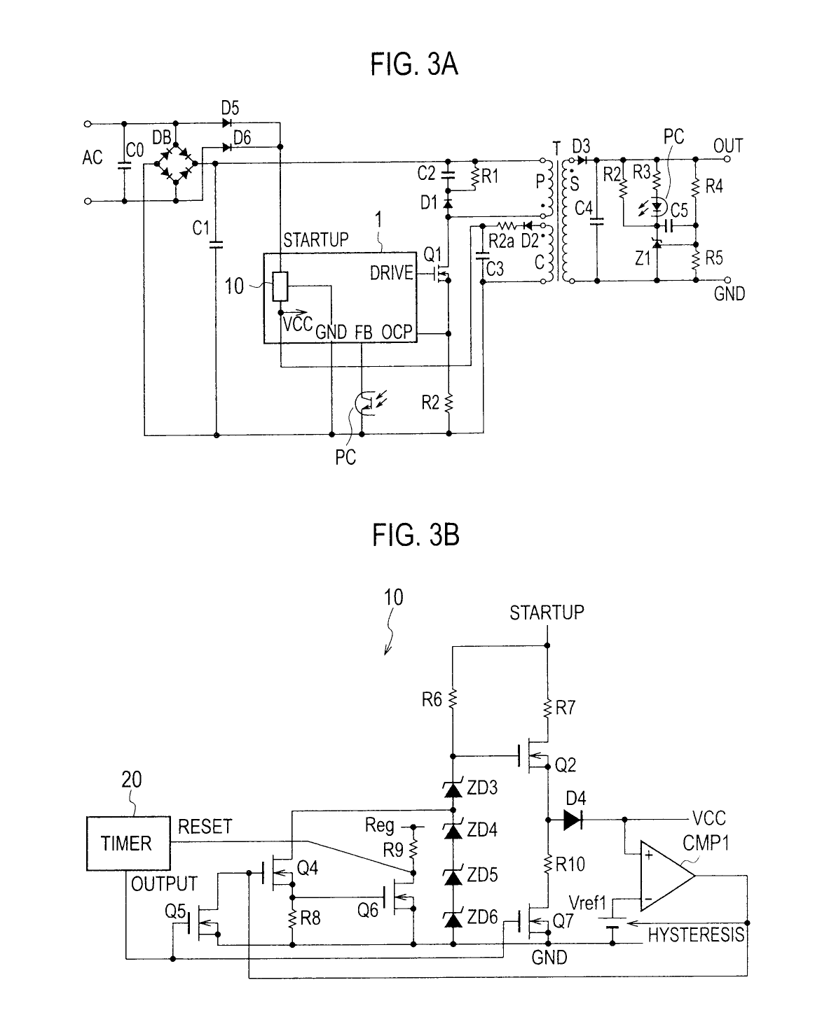

FIG. 3A is a circuit diagram illustrating a switching power source apparatus including a startup circuit according to Embodiment 1 of the present invention and FIG. 3B is a circuit diagram illustrating the startup circuit. The switching power source apparatus includes a controller 1 incorporating the startup circuit 10. In the switching power source apparatus, a first end of a capacitor C0 is connected to an anode of a diode D5, a cathode of the diode D5 is connected to a terminal STARTUP of the controller 1, a second end of the capacitor C0 is connected to an anode of a diode D6, and a cathode of the diode D6 is connected to the terminal STARTUP.

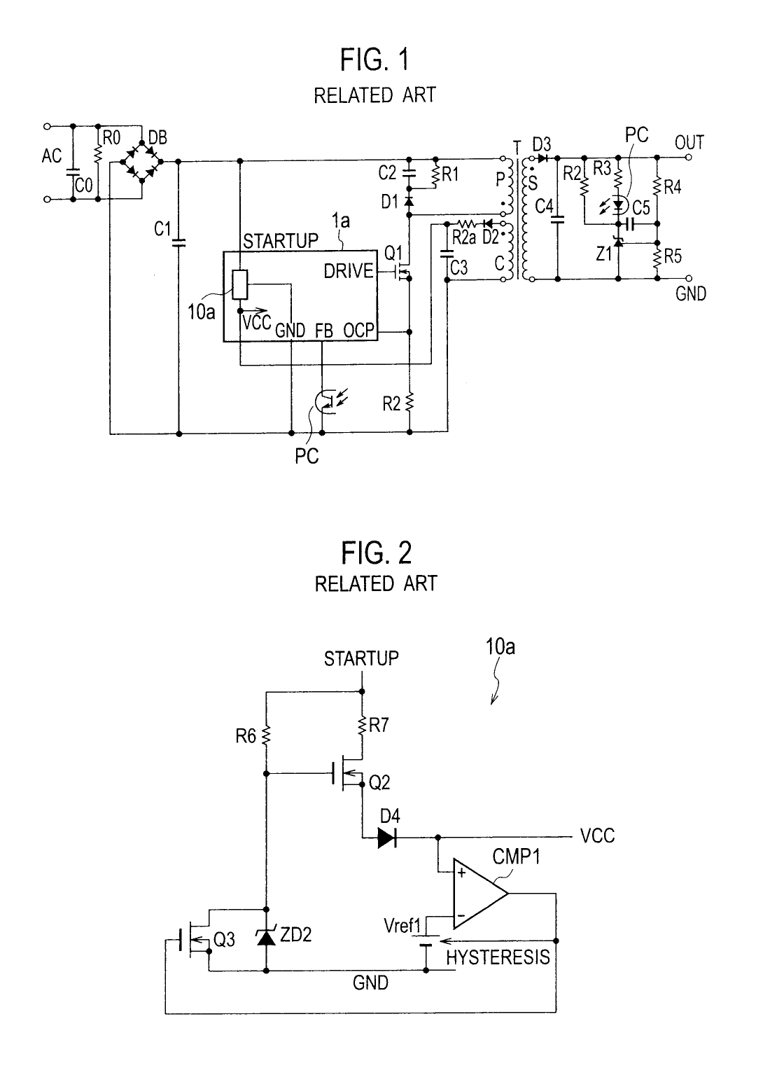

The remaining configuration of FIG. 3A is the same as that of FIG. 1, and therefore, like parts are represented with like reference marks to omit a repetition of explanation.

The controller 1 of FIG. 3A has the same terminals as the controller 1a of FIG. 1 and is different therefrom in that the controller 1 has the startup circuit 10 instead of the startup circuit 10a. The startup circuit 10 will be explained in detail with reference to FIG. 3B.

The startup circuit 10 is integrated as an IC (integrated circuit). In the startup circuit 10, first ends of resistors R6 and R7 are connected to the terminal STARTUP. A second end of the resistor R6 is connected to a series circuit of zener diodes ZD3 to ZD6 and a gate of a switch element Q2 made of a MOSFET.

The resistor R6 is a high-resistance bias resistor and has a resistance of, for example, 200 MΩ). Instead of the resistor R6, a constant current source of about 1 to 20 μA may be used. Each of the zener diodes ZD3 to ZD6 has a breakdown voltage of, for example, 7V to provide a total breakdown voltage of 28 V with the four series-connected zener diodes ZD3 to ZD6.

An anode of the zener diode ZD3 and a cathode of the zener diode ZD4 are connected to a drain of a switch element Q4 made of a MOSFET. A source of the switch element Q4 is connected to a first end of a resistor R8 and a gate of a switch element Q6 made of a MOSFET.

A gate of the switch element Q4 is connected to a drain of a switch element Q5 made of a MOSFET and an output terminal of a hysteresis comparator CMP1. A source of the switch element Q5 is connected to a second end of the resistor R8, a source of a switch element Q6, an anode of the zener diode ZD6, a source of a switch element Q7 made of a MOSFET, a negative electrode of a reference power source Vref1, and a terminal GND (ground) of the controller 1.

A gate of the switch element Q5 is connected to an output terminal of a timer 20 and a gate of the switch element Q7. A drain of the switch element Q6 is connected to a first end of a resistor R9 and a reset terminal of the timer 20. A second end of the resistor R9 is connected to a power source Reg.

A second end of the resistor R7 is connected to a drain of the switch element Q2. A source of the switch element Q2 is connected to a first end of a resistor R10 and an anode of a diode D4. A cathode of the diode D4 is connected to a terminal VCC and a non-inverting input terminal (+) of the hysteresis comparator CMP1. An inverting input terminal (−) of the hysteresis comparator CMP1 is connected to a positive electrode of the reference power source Vref1. The output terminal of the hysteresis comparator CMP1 is connected to the gate of the switch element Q4 and the reference power source Vref1. A second end of the resistor R10 is connected to a drain of the switch element Q7.

The switch elements Q4 and Q6, resistors R6, R8, and R9, and zener diode ZD3 are represented by the “detector” stipulated in the claims. The resistor R10 and switch element Q7 are represented by the “discharger” stipulated in the claims.

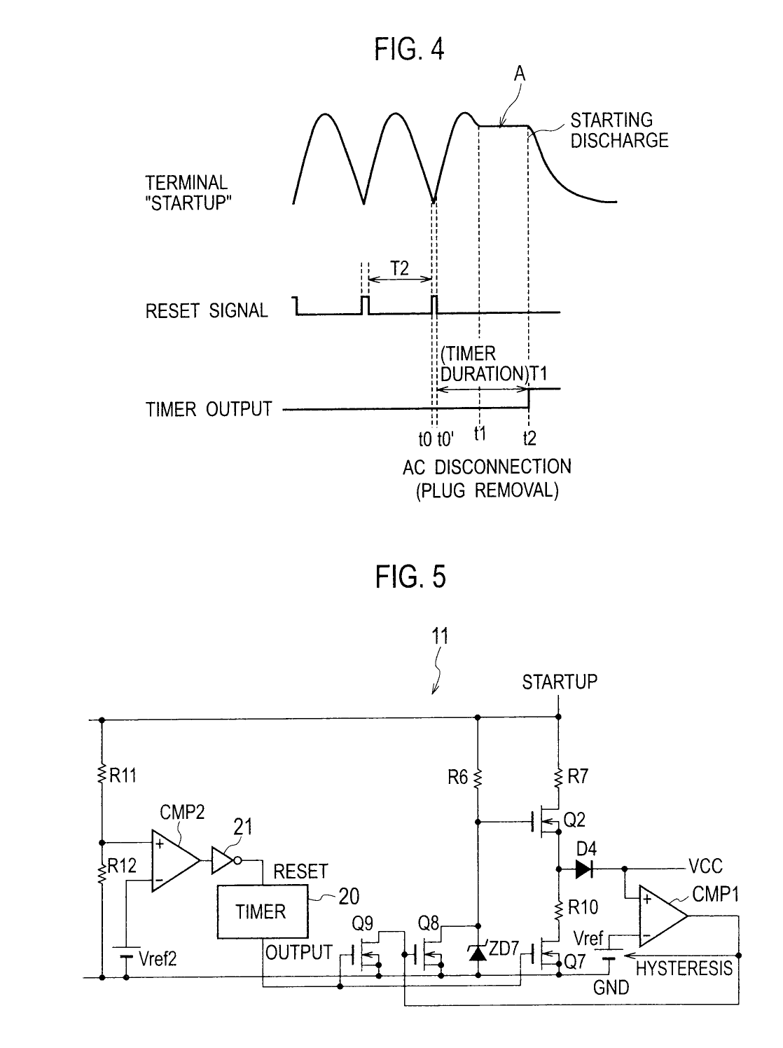

Operation of the startup circuit 10 according to the present embodiment will be explained with reference to the circuit diagram of FIG. 3B and waveform diagram of FIG. 4.

A timer time T1 is set to be longer than a reset signal period T2. The reset signal period T2 is based on a period of a full-wave rectified voltage supplied to the terminal STARTUP.

When an AC power source AC is supplied, an AC voltage therefrom is full-wave-rectified by the diodes D5 and D6 into a full-wave-rectified voltage, which is supplied to the terminal STARTUP. If the voltage at the terminal STARTUP is larger than the breakdown voltage of the zener diodes ZD3 to ZD6, the zener diodes break down to turn on the switch element Q2, supply a current to the terminal VCC, and start up the controller 1. At the same time, the switch element Q4 turns on to pass a current through a path extending along R6, ZD3, Q4, and R8. A voltage drop due to the resistor R8 turns on the switch element Q6 so that the drain of the switch element Q6 becomes low not to provide the timer 20 with a reset signal.

When the voltage at the terminal STARTUP reaches a bottom at, for example, time t0, the zener diode ZD3 does not break down due to the low voltage, thereby blocking the drain-source current of the switch element Q4. As a result, the gate of the switch element Q6 is connected through the resistor R8 to the terminal GND, and therefore, the switch element Q6 turns off to make the drain of the switch element Q6 high. This provides the timer 20 with a reset signal to reset the timer 20. At time t0′, the reset signal disappears and the timer 20 starts to count the timer time T1.

At time t1, the AC power source AC is disconnected by removing an AC plug from an AC socket. At this time, the startup circuit 10 is OFF and has a high impedance value to consume nearly no power. Accordingly, no decrease in voltage occurs at the terminal STARTUP as depicted by a period “A” in FIG. 4. At time t2, the timer time T1 elapses. At this time, if the voltage at the terminal STARTUP is still above a specified voltage (bottom voltage), the timer 20 provides a high-level output to the switch elements Q5 and Q7.

As a result, the switch element Q5 turns on to turn off the switch element Q4 and on the switch element Q2. When the switch element Q7 turns on, the switch element Q2 is ON, and therefore, the voltage at the terminal STARTUP is discharged through the resistor R7 and discharge resistor R10. Accordingly, the capacitor C0 between the AC lines of the AC power source AC is discharged.

Even without the switch element Q7 and resistor R10, the capacitor C0 can be discharged through the terminal STARTUP and the terminal VCC. Accordingly, the switch element Q7 and resistor R10 are not essential.

If the voltage at the terminal STARTUP reaches the specified voltage (bottom voltage) before the elapse of the timer time T1, the timer 20 is reset.

In this way, the present embodiment can eliminate the discharge resistor of the related art connected between the AC lines of the AC power source AC, to reduce power consumption in a standby mode. When the AC plug is removed from the AC socket to disconnect the AC power source AC, the present embodiment discharges the capacitor C0 between the AC lines of the AC power source AC through the terminal STARTUP. This operation is similar to that of the discharge resistor of the related art to prevent an electric shock.

If capacitance between the AC lines must be increased to deal with EMI, the related art must reduce the discharge resistance in some cases because a maximum discharging time is limited by regulations. This results in increasing power consumption in a standby mode.

On the other hand, the present embodiment actively discharges the capacitor C0 when the AC power source AC is disconnected, and therefore, the capacitor C0 between the AC lines of the AC plug may have a larger capacitance than the related art. Accordingly, Embodiment 1 can easily deal with EMI. The timer 20 and other components of Embodiment 1 are manufacturable as an IC to reduce the cost of the switching power source apparatus including the startup circuit 10.

The timer 20 can be realized with a combination of an oscillator (not illustrated) incorporated in the controller 1 and a counter without increasing the number of parts and power consumption.

### Embodiment 2

FIG. 5 is a circuit diagram illustrating a startup circuit according to Embodiment 2 of the present invention. Like the startup circuit 10 of Embodiment 1, the startup circuit 11 of Embodiment 2 is incorporated in the controller 1 illustrated in FIG. 3A. The startup circuit 11 according to Embodiment 2 is characterized in that it resets a timer 20 according to a voltage at the terminal STARTUP.

In the startup circuit 11 of FIG. 5, first ends of resistors R6, R7, and R11 are connected to the terminal STARTUP. A second end of the resistor R6 is connected to a cathode of a zener diode ZD7. The zener diode ZD7 has a zener voltage of, for example, 28 V.

A second end of the resistor R7 is connected to a drain of a switch element Q2. A source of the switch element Q2 is connected to a first end of a resistor R10 and an anode of a diode D4. A cathode of the diode D4 is connected to the terminal VCC and a non-inverting input terminal of a hysteresis comparator CMP1. An inverting input terminal of the hysteresis comparator CMP1 is connected to a positive electrode of a reference power source Vref1.

An output terminal of the hysteresis comparator CMP1 is connected to a gate of a switch element Q8 being a MOSFET, a drain of a switch element Q9 being a MOSFET, and the reference power source Vref1. A second end of the resistor R10 is connected to a drain of a switch element Q7.

A second end of the resistor R11 is connected to a non-inverting input terminal of a comparator CMP2 and a first end of a resistor R12. An inverting input terminal of the comparator CMP2 is connected to a positive electrode of a reference power source Vref2. An output terminal of the comparator CMP2 is connected through an inverter 21 to a reset terminal of the timer 20.

An output terminal of the timer 20 is connected to gates of the switch elements Q9 and Q7. A second end of the resistor R12, a negative electrode of the reference power source Vref2, sources of the switch elements Q7, Q8, and Q9, and a negative electrode of the reference power source Vref1 are connected to the terminal GND (ground).

The resistors R11 and R12, comparator CMP2, reference power source Vref2, and inverter 21 are represented by the “detector” stipulated in the claims. The resistor R10 and switch element Q7 are represented by the “discharger” stipulated in the claims.

Operation of the startup circuit 11 according to the present embodiment will be explained. Operation at startup of the AC power source AC and operation in a normal state are the same as those of the related art illustrated in FIG. 2, and therefore, will not be explained.

Operation of the startup circuit 11 when the AC power source AC is disconnected will be explained with reference to FIG. 4. If a voltage at the terminal STARTUP is around a peak, a potential at the non-inverting input terminal of the comparator CMP2 is larger than that at the inverting input terminal thereof, and therefore, the comparator CMP2 provides the inverter 21 with a high-level output. The inverter 21, therefore, provides the timer 20 with a low-level output not to reset the timer 20.

At time t0, the voltage at the terminal STARTUP reaches a bottom, so that the potential at the non-inverting input terminal of the comparator CMP2 becomes lower than that at the inverting input terminal thereof. Accordingly, the comparator CMP2 provides the inverter 21 with a low-level output. The inverter 21 then provides the timer 20 with a high-level output to reset the timer 20. At time t0, the reset signal disappears and the timer 20 starts to count a timer time T1.

At time t1, the AC power source AC is disconnected. At time t2, the timer time T1 elapses. At this moment, if the voltage at the terminal STARTUP is higher than the bottom voltage (or a specified voltage), the timer 20 provides the switch elements Q7 and Q9 with a high-level output.

As a result, the switch element Q9 turns on to turn off the switch element Q8 and turn on the switch element Q2. When the switch element Q7 turns on, the switch element Q2 is ON, and therefore, the voltage at the terminal STARTUP is discharged through the resistor R7 and discharge resistor R10, thereby discharging the capacitor C0 connected between AC lines of the AC power source AC.

In this way, the startup circuit 11 of Embodiment 2 provides an effect similar to that provided by the startup circuit 10 of Embodiment 1.

As mentioned above, the startup circuit according to any one of the embodiments of the present invention detects if a rectified voltage is equal to or lower than a predetermined voltage, counts a predetermined time with a timer, determines that an AC power source is disconnected if the rectified voltage does not reach a specified voltage within the predetermined time counted by the timer, and discharges the rectified voltage through the discharger. The startup circuit of the present invention, therefore, can eliminate the discharge resistor of the related art connected between AC lines of an AC plug, thereby reducing power consumption in a standby mode.

The startup circuit according to the present invention is applicable to switching power source apparatuses.

This application claims benefit of priority under 35USC §119 to Japanese Patent Application No. 2010-158684, filed on Jul. 13, 2010, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A startup circuit installed in a switching power source apparatus that rectifies and smooths an AC voltage from an AC power source into a rectified-and-smoothed voltage, turns on/off the rectified-and-smoothed voltage with a controller to generate high-frequency voltages on primary and secondary windings of a transformer, and rectifies and smooths the high-frequency voltage of the secondary winding into a DC output voltage,
the startup circuit being configured to start up the controller by use of the rectified voltage at startup of the AC power source and comprising:
a detector configured to detect if the rectified voltage is equal to or lower than a predetermined voltage;
a timer configured to count a predetermined time after the rectified voltage is detected to be equal to or lower than the predetermined voltage; and
a discharger configured to discharge the rectified voltage if the rectified voltage does not become equal to or lower than a specified voltage within the predetermined time counted by the timer.

2. The startup circuit of claim 1, wherein
the discharger includes a series circuit having a discharge resistor and a switch element, and
turns on the switch element according to an output from the timer to discharge the rectified voltage through the discharge resistor.

3. The startup circuit of claim 1, wherein
the detector includes a comparator to compare the rectified voltage with the predetermined voltage.

4. The startup circuit of claim 2, wherein
the detector includes a comparator to compare the rectified voltage with the predetermined voltage.
